(19) United States
(12) Patent Application Publication
(10) Pub. No.: US 2008/0201569 A1
(43) Pub. Date: Aug. 21, 2008

(54) DUAL CPU INVERTER SYSTEM AND METHOD FOR THE SAME

(76) Inventors: Hsiao-Yuan Wen, Taoyuan Shien (TW); Saw-You Tsai, Taoyuan Shien (TW)

Correspondence Address: HDSL, 4331 STEVENS BATTLE LANE, FAIRFAX, VA, 22033, US

(21) Appl. No.: 11/677,137

(22) Filed: Feb. 21, 2007

(51) Int. Cl. G06F 9/00

(52) U.S. Cl. 713/1

(57) ABSTRACT

A dual CPU inverter system includes a power module and a control module electrically connected to each other and each having a CPU, a RAM and a ROM. After power on, the two modules can read the respective ROM data to the respective RAM to speed up the ready state. When external IO intends to store command parameters, the dual CPU inverter system can judge which module is the destination for the command parameter and send the command parameter to the ROM respectively. Therefore, the communication load between the two modules can be reduced.

### BACKGROUND OF THE INVENTION

1. Field of the Invention

The present invention relates to a dual CPU inverter system and method for the same, especially to a dual CPU inverter system with speeding-up power on process and reducing CPU communication load and method for the same.

2. Description of Prior Art

The electrical power for household and industrial application generally has constant voltage and frequency. An inverter is a device to convert the electrical power of constant voltage and frequency to e electrical power of variable voltage and frequency. An inverter system first converts an AC power into DC power through rectifying, and then converts the DC power into AC power with variable voltage and frequency. The AC power output from the inverter is a quasi-sinusoidal wave and can be used to drive AC induction motor.

Beside speed control application, the inverter is also used for energy conservation. Therefore, inverter is extensively used for household and industrial applications such as refrigerator, washing machine, air condition and industrial machine, where inverter can advantageously change the voltage and frequency of AC power for optimal energy consumption.

A dual-CPU system generally has shared read-only memory (ROM) and random accessing memory (RAM) for accessing data. A dual-CPU inverter system comprises a first CPU at waveform power module of primary side and a second CPU at IO control unit of secondary side. For modularization, the waveform power module should be used with different IO control modules and the two modules have their own ROMs for accessing respective parameters.

Moreover, to save pin counts, the dual-CPU system generally uses two pins for data communication between the two modules. It is an important issue for effective management of data accessing for these two modules.

FIG. 1 shows a block diagram of a prior art dual-CPU inverter system. The dual-CPU inverter system comprises a waveform power module 10A at primary side and an IO control module 12A at secondary side. The waveform power module 10A comprises a first CPU 10A, a first RAM 102A and a first ROM 104A. The IO control module 12A comprises a second CPU 120A, a second RAM 122A.

FIG. 2 shows a control flowchart of the prior art dual-CPU inverter system shown in FIG. 1. After power on (step 20A), the waveform power module 10A reads the data of the first ROM 104A into the first RAM 102A (step 22A) and sends the data for the IO control module 12A to the IO control module 12A (step 24A). The waveform power module 10A checks whether the data synchronization is finished (step 26A). The waveform power module 10A performs initialization (step 28A) and enters ready state (step 30A) after the data synchronization is finished. After power on (step 40A), the IO control module 12A sends the data from the waveform power module 10A to the second RAM 122A thereof (step 42A) and then checks whether the data synchronization is finished (step 44A). The IO control module 12A performs initialization (step 46A) and enters ready state (step 50A) after the data synchronization is finished. Otherwise, the IO control module 12A displays message such as “hello” informing user to wait (step 48A).

FIG. 3 shows the flowchart of storing command parameter for external IO in the prior art dual-CPU inverter system shown in FIG. 1. When the external IO intends to store command parameter (step 60A), the IO control module 12A first stores the command parameter in the second RAM 122A thereof (step 62A). Afterward, the IO control module 12A sends the command parameter to be stored to the waveform power module 10A through a communication interface (step 64A). The waveform power module 10A then stores the command parameter to the first ROM 104A thereof (step 66A) and the storing of command parameter is ended (step 68A).

However, the above-mentioned prior art dual-CPU inverter system has following problems.

1. The command parameter is stored in only one ROM of one module. Therefore, two modules need to exchange parameters through the communication interface after power on. The waiting time may last 5-7 seconds and some dual-CPU inverter system displays message such as “Hello” or manufacture logo during the waiting time. This causes inconvenience for user.

2. Each parameter should be sent to another module through a communication interface before storing to ROM. The load of CPU communication is increased.

### SUMMARY OF THE INVENTION

It is an object of the present invention to provide a dual CPU inverter system for reducing waiting time of user and method for the same.

It is another object of the present invention to provide a dual CPU inverter system for enhancing communication efficiency and method for the same.

Accordingly, the present invention provides a dual-CPU inverter system comprising a waveform power module and an IO control module electrically connected to the waveform power module. The waveform power module comprises a first CPU, a first RAM and a first ROM both electrically connected tot the first CPU. The IO control module comprises a second CPU, a second RAM and a second ROM both electrically connected to the second CPU. The dual-CPU inverter system comprises a data classification unit to judge a target location of an external IO.

Accordingly, the present invention provides a method for operating a dual-CPU inverter system, comprising:

providing a waveform power module, which comprises a first CPU, a first RAM and a first ROM both electrically connected tot the first CPU;

providing an IO control module, which is electrically connected to the waveform power module and comprises a second CPU, a second RAM and a second ROM both electrically connected to the second CPU;

the waveform power module reading data in the first ROM after power on; and

the IO control module reading data in the second ROM after power on.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a block diagram of a prior art dual-CPU inverter system.

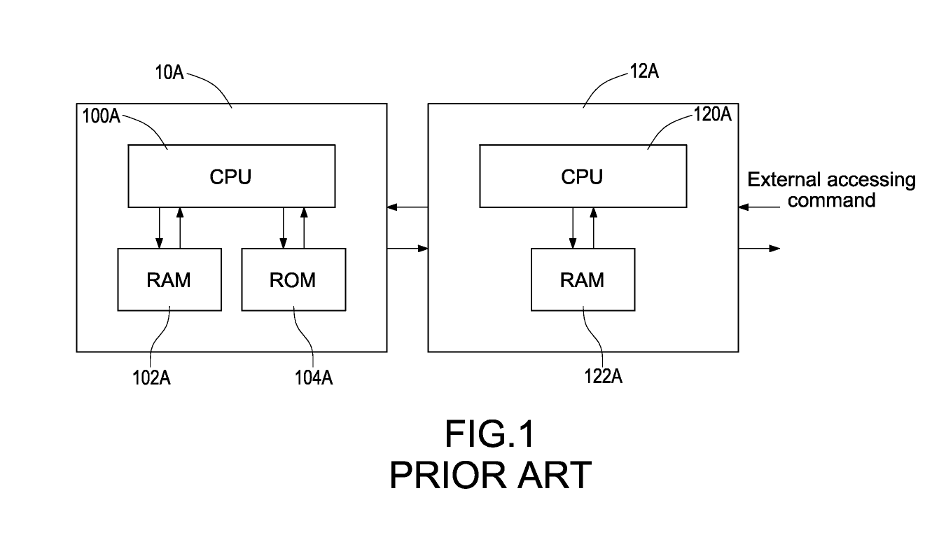

FIG. 2 shows a control flowchart of the prior art dual-CPU inverter system shown in FIG. 1.

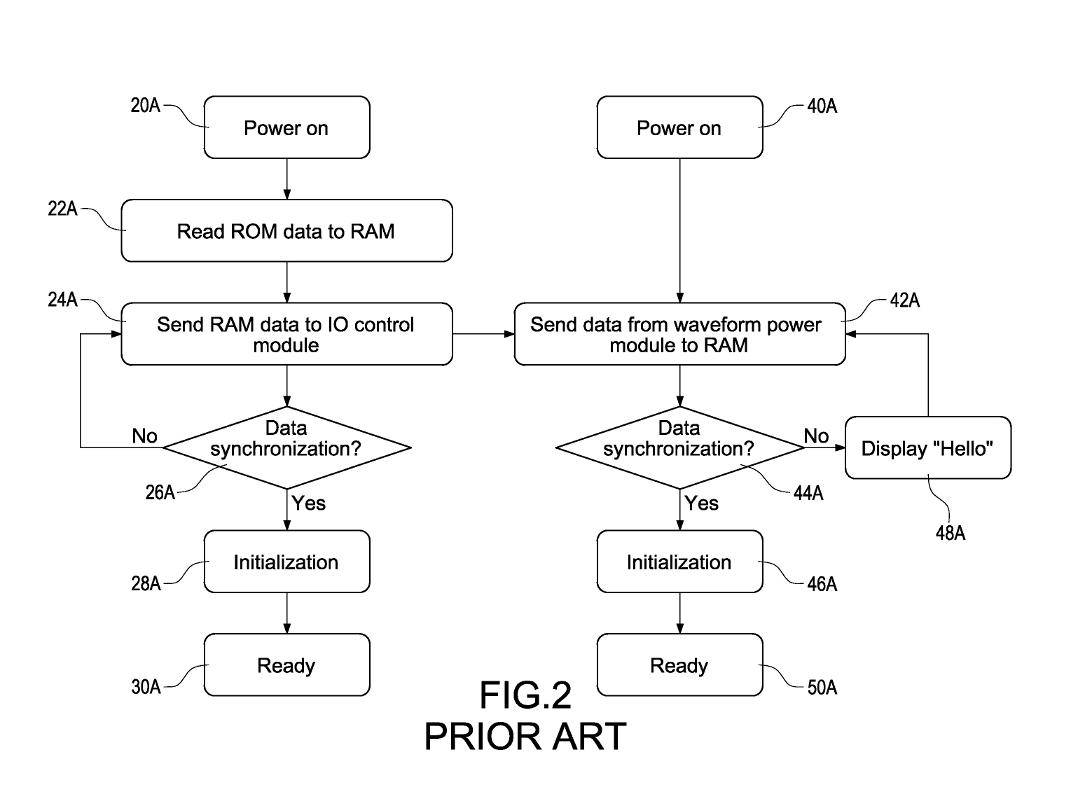

FIG. 3 shows the flowchart of storing command parameter for external IO in the prior art dual-CPU inverter system shown in FIG. 1.

FIG. 4 shows a block diagram of the dual-CPU inverter system according to the present invention.

FIG. 5 shows a control flowchart of the dual-CPU inverter system shown in FIG. 3.

FIG. 6 shows the flowchart of storing command parameter for external IO in the dual-CPU inverter system shown in FIG. 3.

### DETAILED DESCRIPTION OF THE INVENTION

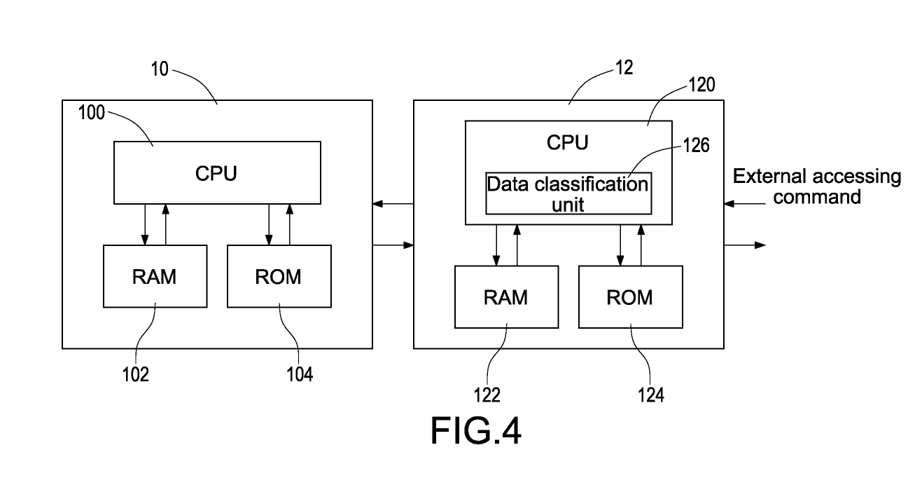

FIG. 4 shows a block diagram of the dual-CPU inverter system according to the present invention. The dual-CPU inverter system according to the present invention comprises a waveform power module 10 at primary side and an IO control module 12 at secondary side. The waveform power module 10 comprises a first CPU 100, a first RAM 102 and a first ROM 104. The IO control module 12 comprises a second CPU 120, a second RAM 122 and a second ROM 124, where the second CPU 120 comprises a built-in data classification unit 126.

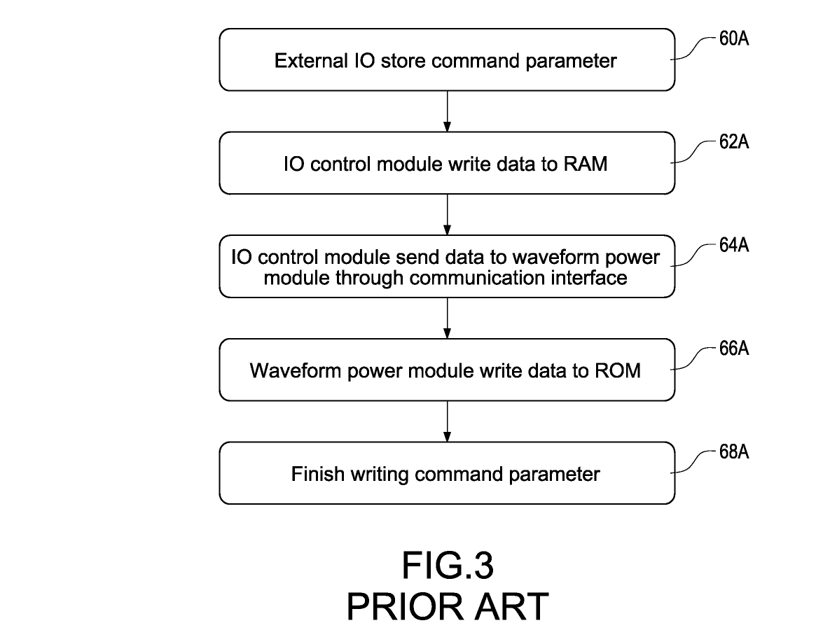

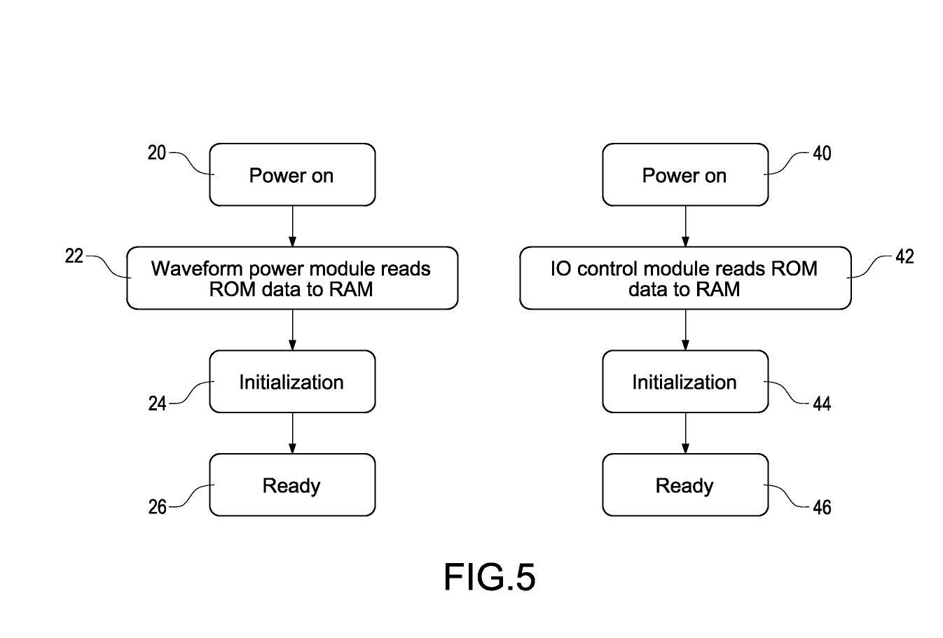

FIG. 5 shows a control flowchart of the dual-CPU inverter system shown in FIG. 3. After power on (step 20), the waveform power module 10 reads the data of the first ROM 104 into the first RAM 102 (step 22). Afterward, the waveform power module 10 performs initialization (step 24) and enters ready state (step 26). After power on (step 40), the IO control module 12 reads the data of the second ROM 124 into the second RAM 122 (step 42). Afterward, the IO control module 12 performs initialization (step 44) and enters ready state (step 46). As can be seen from above description, the IO control module 12 comprises a second ROM 124 and can directly read the data of the second ROM 124 into the second RAM 122. Exchange of parameter through communication interface is not necessary after power on, and the ready state can be speeded up.

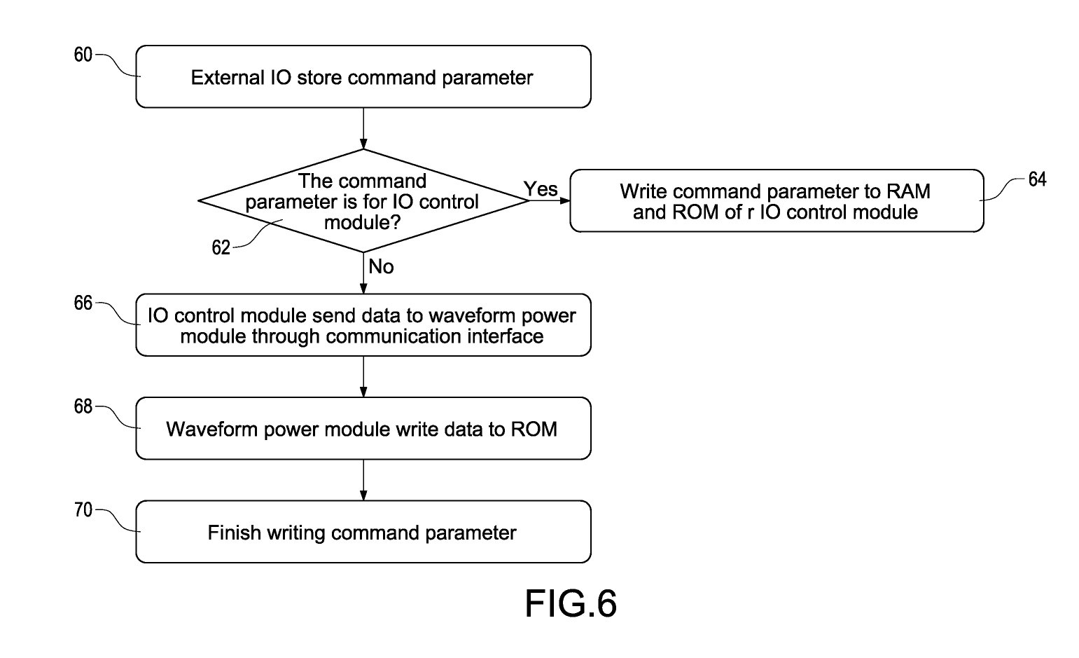

FIG. 6 shows the flowchart of storing command parameter for external IO in the dual-CPU inverter system shown in FIG. 3. When the external IO intends to store command parameter (step 60), the data classification unit 126 in the IO control module 12 judges whether the command parameter is for the IO control module 12 (step 62). If true, the command parameter is stored to the second RAM 122 and the second ROM 124 (step 64). If false, the IO control module 12 sends the command parameter to the waveform power module 10 through the communication interface (step 66). The waveform power module 10 stores the command parameter to the first ROM 104 (step 68) and the parameter update for the waveform power module 10 and the IO control module 12 is finished (step 70).

In above-mentioned steps, the command parameter is selectively stored in the ROM of either the waveform power module 10 or the IO control module 12, based on the judgment of the data classification unit 126. Therefore, the first ROM 104 and the second ROM 124 can adopt chip with smaller capacity. Some command parameter exclusive for the IO control module 12, such as Keypad display selection and Multi-input function selection will not be stored to the waveform power module 10. Moreover, some command parameter exclusive for the waveform power module 10 such as PWM carrier freq and max output freq/voltage will not be stored to the IO control module 12. The loading of CPU communication can be reduced. Moreover, the databases of the two modules are independent. Only one module needs modification for the parameter update, which render convenience to software maintenance and factory rework.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A dual-CPU inverter system, comprising:
a waveform power module comprising a first CPU, a first RAM and a first ROM both electrically connected tot the first CPU; and
an IO control module electrically connected to the waveform power module and comprising a second CPU, a second RAM and a second ROM both electrically connected to the second CPU,
wherein the dual-CPU inverter system comprises a data classification unit to judge a target location of an external IO.

2. The dual-CPU inverter system in claim 1, wherein the waveform power module and the IO control module are electrically connected through a communication interface.

3. The dual-CPU inverter system in claim 2, wherein the waveform power module and the IO control module are electrically connected to the communication interface through two pins.

4. The dual-CPU inverter system in claim 1, wherein the first ROM and the second ROM are ERPROM.

5. The dual-CPU inverter system in claim 1, wherein the data classification unit is built in the second CPU.

6. A method for operating a dual-CPU inverter system, comprising:
providing a waveform power module, which comprises a first CPU, a first RAM and a first ROM both electrically connected tot the first CPU;
providing an IO control module, which is electrically connected to the waveform power module and comprises a second CPU, a second RAM and a second ROM both electrically connected to the second CPU;
the waveform power module reading data in the first ROM after power on; and
the IO control module reading data in the second ROM after power on.

7. The method in claim 6, further comprising:
checking whether a command parameter sent from an external IO is for the IO control module.

8. The method in claim 7, further comprising:
storing the command parameter to the second RAM and the second ROM of the IO control module when the command parameter is for the IO control module.

9. The method in claim 7, further comprising:
storing the command parameter to the first RAM and the first ROM of the waveform power module when the command parameter is not for the IO control module.

10. The method in claim 9, further comprising:
sending the command parameter to the waveform power module through a communication interface between the waveform power module and the IO control module.
